(19) United States
(12) Patent Application Publication
(10) Pub. No.: US 2010/0231336 A1
(43) Pub. Date: Sep. 16, 2010

(54) Structure made of a soft component and a magnet that connects a collector pin to a metal surface

(76) Inventor: Jeff Allen Ricks, San Francisco, CA (US)

Correspondence Address: Benjamin I. Edlavitch, PO BOX 220661, Chicago, IL, 60622-0661, US

(21) Appl. No.: 12/381,505

(22) Filed: Mar. 12, 2009

(51) Int. Cl. H01F 7/02

(52) U.S. Cl. 335/285

(57) ABSTRACT

A structure that allows a collector pin or button to connect to a metal surface without damaging the sharp point or shaft of the collector pin or button. The structure includes a soft component that receives the point and shaft portion of the collector pin or button and a magnet that allows the combination of the structure and the collector item to attach to a metal surface. The soft component is large enough to receive the point and shaft of the collector item without the point or shaft touching, pressing against, or interfering with the magnet.

### BACKGROUND

Themes of collector pins and buttons (i.e. collector pins) embrace almost every human endeavor, including sports, politics, travel, entertainment, education, civil services, and ceremonies. For example, there is a large market for historic campaign pins and buttons. Other popular collector pins display graphics or text expressing humor or beliefs. In addition, collector pins have sentimental value and are often heirlooms.

One aspect of collecting pins and buttons is displaying them. Because a collector pin attaches to an article by penetrating the article, collectors of such an item are limited to displaying the item on fabrics or other soft materials. Typically, collectors display collector pins by fastening them to a corkboard, an article of clothing, or a pennant.

The attachment mechanism on a collector pin is primarily a pin and latch mechanism. The pin attaches to a soft material by poking through the material, and the latch secures the pin to the material once the pin has poked through the material. Because of the attachment mechanism, it is difficult to attach collector pins to a hard surface without damaging the sharp point and shaft of collector pins. This is unfortunate, since there are many hard surfaces in a residence, showroom, or workplace that would be suited for displaying a collector pin.

One type of hard surface is a metal surface. One advantage of a metal surface is that a magnet can connect an item to a metal surface. For the most part, connecting an item to a metal surface using a magnet does not cause damage to the surface, item, or magnet.

### SUMMARY OF THE INVENTION

The structure described herein connects a collector pin to a metal surface without damaging the sharp point or shaft portions of the collector pin. The structure includes a soft component that receives the point and shaft portion of a collector pin, and a magnet that attaches the combination of the structure and the collector pin to a metal surface.

The soft component is large enough to receive the point and shaft portion of a collector pin without the point and shaft touching, pressing against, or interfering with the magnet.

In one embodiment of the structure, the magnet fits into a depression in the soft component. The magnet attaches to the depression by either a tight fit or an adhesive.

In another embodiment of the structure, the soft component encloses the magnet.

In one embodiment of the structure, the overall shape of the structure resembles a frustum. The slope of a side surface of a frustum assists the point portion of a pin in penetrating the side surface. Moreover, the varying widths throughout the body of a frustum are advantageous in attaching a shaft portion of a collector pin to the soft component, because the length of the shaft portion varies in different pins.

In one embodiment of the structure, the height of the magnet is significantly smaller than the height of the soft component. For example, in one embodiment of the structure, the height of the magnet is at most twenty-five percent the height of the soft component.

### BRIEF DESCRIPTION OF THE DRAWINGS

Below is a brief description of example embodiments of the structure in conjunction with appended drawings, wherein like reference numerals refer to like elements in the drawings, and wherein:

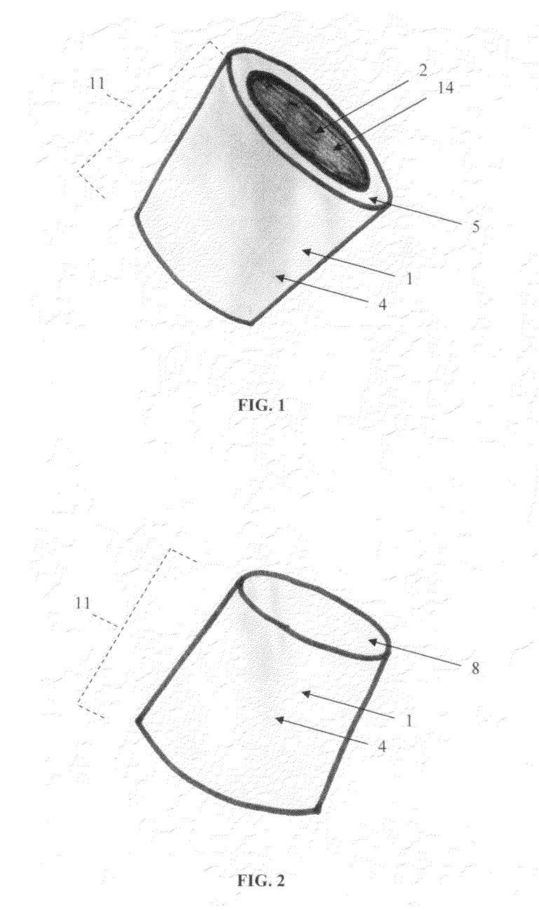

figures one and two (labeled “FIG. 1” & “FIG. 2” in the drawings) are illustrations of an example embodiment of the structure, where the shape of the structure resembles a conical frustum;

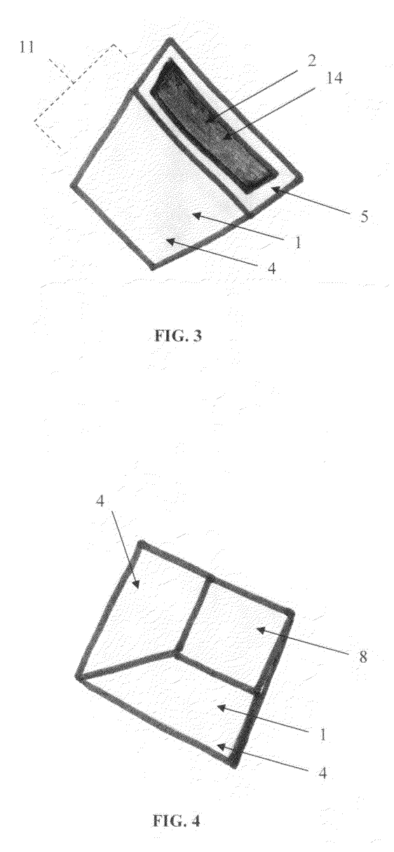

figures three and four (labeled “FIG. 3” & “FIG. 4” in the drawings) are illustrations of an example embodiment of the structure, where the shape of the structure resembles a pyramidal frustum;

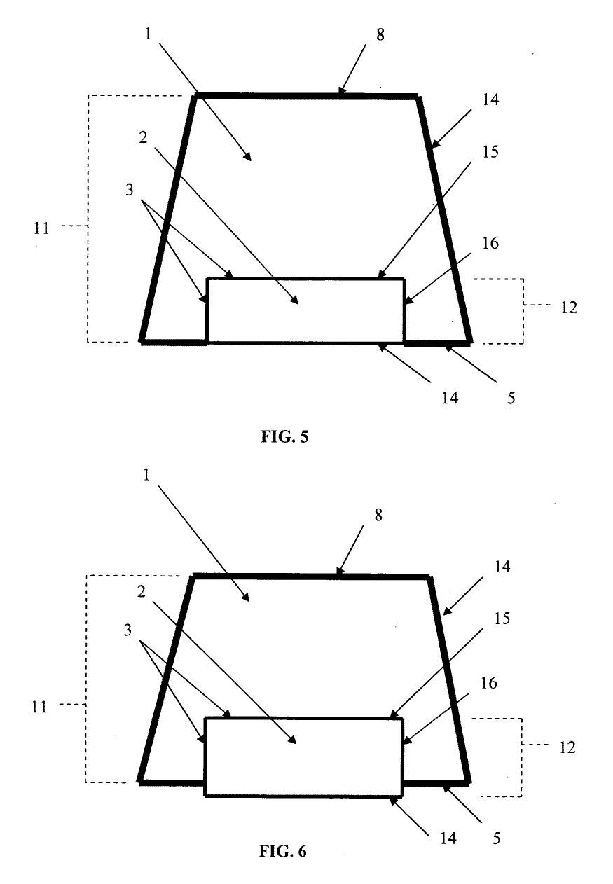

figure five (labeled “FIG. 5” in the drawings) is a cross section of an example embodiment of the structure, where a bottom surface of the magnet is approximately in the same plane as a bottom surface of the soft component; and

figure six (labeled “FIG. 6” in the drawings) is a cross section of an example embodiment of the structure, where the magnet extends out from the bottom of the soft component.

### DETAILED DESCRIPTION

The present specification explains embodiments of a structure made of a soft component and a magnet that connects a collector pin or button (i.e. collector pin) to a metal surface. The present detailed description does not limit the structure and the structure embodies various forms. Figures one through six illustrate example embodiments of the structure and the figures are merely devices for assisting the explanation of the present detailed description and do not limit the scope of the structure. Furthermore, the figures are not drawn to scale.

Embodiments of the structure vary in shape and size.

The combination of the soft component and the magnet allows a point and shaft of a pin to penetrate the soft component without damage to the point or shaft. The size of the magnet is limited in that the magnet cannot touch, press against, or interfere with the point and shaft of a pin going through the soft component.

The soft component has a height, two base surfaces, and at least one side surface. The magnet has a height, two base surfaces, and at least one side surface. In one embodiment, the height of the magnet is less than the height of the soft component, which allows for the point and shaft of a collector pin to insert through the soft component without touching the magnet. Avoiding contact between the magnet and a pin limits the probability that the structure damages the pin.

In one embodiment of the structure, the height of the magnet is five to fifteen percent of the height of the soft component.

In another embodiment of the structure, the height of the magnet is fifteen to twenty-five percent of the height of the soft component.

In another embodiment of the structure, the height of the magnet is less than five percent of the height of the soft component. In this embodiment, the material that makes up the magnet must be highly magnetized, or the magnet has a large width.

In one embodiment of the structure, the soft component and the magnet are approximately the same shape and size. The shape of the magnet and soft component may resemble various logos, cartoon characters, and other recognizable shapes. This embodiment of the structure typically sells with a metal board displaying a scene. Hypothetically, in the case of collector pins that display fairytale characters, a board displaying a magical castle sells with such pins. In addition, in this embodiment of the structure, an adhesive attaches the magnet to the soft component.

As explained above and as illustrated in figures one through six, the structure is a combination of a soft component 1 and a magnet 2. The soft component 1 has a height 11, two base surfaces 5 & 8, and at least one side surface 4. The magnet 2 has a height 12, two base surfaces 14 & 15, and at least one side surface 16.

In one embodiment of the structure, the soft component has two base surfaces varying in area, where the bottom base surface is larger than the top base surface.

In figures one through six, the bottom base surface 5 is larger than the top base surface 8. The structures in the figures resemble a frustum, which is usually the case when the bottom base surface is larger than the top base surface. Where the structure resembles a frustum, it resembles a frustum in the sense that the two base surfaces have the same two-dimensional shape and vary in area. The two-dimensional shape that makes up the two base surfaces is any shape, including rectangular shapes, circular shapes, star shapes, and shapes that resemble recognizable logos and cartoon characters.

In figures five and six, the embodiment of the structure includes a depression in the bottom base surface 5 of the soft component 1, where the magnet 2 abuts the soft component 1. The depression is a receptor area for the magnet 2.

In figures five and six, the side surface 16 and top base surface 15 of the magnet abut the surface of the depression 3.

In one embodiment of the structure, the magnet attaches to the depression of the soft component by tightly fitting into the depression of the soft component.

In another embodiment of the structure, an adhesive attaches the magnet to the surface of the depression.

In one embodiment of the structure where the magnet 2 has a bottom base surface 14, the bottom base surface 14 of the magnet 2 is approximately in the same plane as the bottom base surface 5 of the soft component 1 (see figure five).

However, as shown in figure six, in another embodiment of the structure, the magnet 2 extends out from the bottom surface 5 of the soft component 1.

In another embodiment of the structure, the soft component encases the magnet. In the embodiment where the soft component encases the magnet, there must be a section of the soft component large enough to receive the shaft and point of a pin without the shaft or point touching, pressing against, or interfering with the magnet.

In one embodiment of the structure, the top and bottom surface of the soft component and magnet are flat. In this embodiment, an adhesive, which is between the abutting surfaces of the magnet and soft component, fastens the magnet to the soft component.

In the embodiment of the structure where the magnet tightly fits into a depression of the soft component, an adhesive may or may not exist between the abutting surfaces of the magnet and soft component.

In one embodiment of the structure where the magnet tightly fits into a depression of the soft component, there are no cavities between the abutting surfaces of the magnet and the depression.

The soft component is composed of a soft rubber, foam, or cork. The soft component must be soft enough so that when a point and shaft of a collector pin inserts into the soft component there is no noticeable damage to the point or shaft. However, the soft component must be sturdy enough to hold a collector pin.

In one embodiment of the structure, the soft component is durable enough so that when a collector pin stabs the soft component several times the soft component retains its shape and ability to hold a collector pin.

In one embodiment of the structure, the magnet is strong enough so that its adhesion to most metal surfaces can withstand the weight of most collector pins in combination with the structure. In other words, the magnet is strong enough to fix the structure to a metal surface when a collector pin is in combination with the structure.

1. A structure that connects a collector pin to a metal surface, comprising in combination:
a soft component that comprises a height, two base surfaces, and at least one side surface, wherein the soft component is soft enough so that a point and a shaft of the collector pin can penetrate the soft component without noticeable damage to the point and the shaft of the pin, and wherein the soft component is sturdy enough to support the weight of the collector pin;
a magnet that comprises a height, two base surfaces, and at least one side surface, wherein the magnet is strong enough to attach the structure to the metal surface when the collector pin is in combination with the structure; and
a section of the soft component that has a large enough volume so that the point and the shaft of the collector pin can penetrate the section without touching the magnet.

2. The structure of claim 1, wherein:
the soft component and the magnet are approximately the same size and shape;
and
an adhesive attaches the magnet with the soft component.

3. The structure of claim 1, wherein:
the two base surfaces of the soft component vary in area; and
one of the base surfaces of the magnet attaches to the base surface of the soft component with a greater area.

4. The structure of claim 3, wherein:
the base surface of the soft component with the greater area comprises a depression; and
the magnet tightly fits into the depression so that the magnet attaches to the soft component.

5. The structure of claim 4, further comprising an adhesive that is between a surface of the depression and a surface of the magnet that abuts the surface of the depression.

6. The structure of claim 4, wherein:
the shape of the soft component resembles a frustum;
the magnet comprises a bottom surface that is approximately in the same plane as the larger base surface of the soft component; and
the height of the magnet is no greater than twenty-five percent the height of the soft component.

7. The structure of claim 4, wherein there are no cavities between the abutting surfaces of the magnet and the depression.

8. The structure of claim 1, wherein the two base surfaces of the soft component are the same two-dimensional shape.

9. The structure of claim 1, wherein the soft component consists of a material selected from a group of soft materials consisting of soft rubbers, soft solid foams, and cork.
